(19) United States
(12) Patent Application Publication
(10) Pub. No.: US 2002/0037060 A1
(43) Pub. Date: Mar. 28, 2002

(54) Digital down-converter and receiver

(75) Inventor: Takahiko Kishi, Yokohama (JP)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 09/931,124

(22) Filed: Aug. 16, 2001

(30) Foreign Application Priority Data
Aug. 17, 2000 (JP) 2000-247862

(51) Int. Cl. H04L 27/08; H04B 1/10

(52) U.S. Cl. 375/345; 375/350

(57) ABSTRACT

A digital down-converter and a receiver capable of reducing power consumption. The digital down-converter converts a frequency of a signal, received at a radio receiver and sampled with a radio frequency (RF) or an intermediate frequency (IF), to a detection frequency for a detection process. The digital down-converter comprises a first mixer for converting a frequency of the received signal to a frequency of a first IF signal; and a second mixer for converting the first IF signal converted by the first mixer to a second IF signal of the detection frequency, and complexing the converted signal.

### PRIORITY

This application claims priority to an application entitled “Digital Down-Converter and Receiver” filed in the Japanese Patent Office on Aug. 17, 2000 and assigned Ser. No. 2000-247862, the contents of which are hereby incorporated by reference.

### BACKGROUND OF THE INVENTION

1. Field of the Invention

The present invention relates to a digital down-converter and a receiver for sampling a received radio signal with a radio frequency (RF) or an intermediate frequency (IF) and then performing digital signal processing on the sampled signal.

2. Description of the Related Art

A conventional digital down-converter (DDC), which is a typical type of a frequency converter of a digital signal processing circuit in a data communication receiver will be described with reference to FIG. 4.

Referring to FIG. 4, an input signal 100 applied to the DDC, which is a modulated RF or IF signal, is a sample signal of frequency Fs1 and an IF carrier of frequency Fif1, modulated by the above sample signal. We solved this problem by amending FIG. 1. For detection, the input signal 100 is mixed with a cosine wave and a sine wave of a frequency Fc output from a local oscillator (or a direct digital synthesizer (DDS)) 102 by a mixer 101a and a mixer 101b. When the frequency Fc of the cosine wave and the sine wave, output from the DDS 102, is set to satisfy a relationship of Fc=Fif1, the input signal 100 is converted at once to a detection process frequency for the sample signal. The detected sample signals are 1/n-down-sampled by sampling rate converters 103a and 103b, and reproduced into baseband signals of frequency Fb. Here, if the frequency of the input signal is Fs1 and a frequency of output signals of the sampling rate converters 103a and 103b is Fs2, then there exists a relationship of Fs2=Fs1/n. The baseband signals are rolloff-shaped by rolloff filters 104a and 104b, and then, variably amplified by automatic gain control (AGC) amplifiers 105a and 105b. That is, the sample signal is output as two baseband signals of an in-phase component I signal and a quadrature component Q signal.

As stated above, in a receiver which samples the received RF or IF signal and performs signal selection and detection by digital signal processing, the digital down-converter (DDC) as a signal processing circuit for processing the sampled, signal converts the received signal at once to a signal for detection (generally to a baseband signal), typically using a real-complex mixer (quadrature converter). The mixers in the initial stage and the local oscillator (DDS) providing a local signal to the mixers, must operate at high speed in order to operate at the game frequency as the sampling frequency for analog-to-digital (A/D) conversion. In addition, the power consumption at the mixers and the local oscillator takes a considerably large part of the total power consumption of the DDC. In particular, the power consumption at the mixers and the local oscillator is greater compared with the power consumption of the rear stage where the sampling frequency is lowered by down-sampling.

Meanwhile, even though the DDS outputting the cosine wave and the sine wave are embodied by uniting a frequency operator and a ROM (Read Only Memory) into one body, data must be read out at least twice in order to read out cosine data and sine data in one sampling period. Therefore, the power consumption of the ROM, which takes most of the overall power consumption, becomes doubled due to two changes of address and output data. Further, the DDS also consumes approximately double power compared with when outputting a single wave.

In addition, in order to convert the IF signal to a baseband signal having no offset, a high-precision process such as subdivided frequency steps is required. Also, in order to obtain a low spurious signal, it is necessary to increase an operation word length of a phase operation circuit and also increase a capacity of the ROM.

### SUMMARY OF THE INVENTION

It is, therefore, an object of the present invention to provide a digital down-converter and a receiver capable of reducing power consumption.

To achieve the above and other objects, there is provided a digital down-converter for converting a frequency of a signal, received at a radio receiver and sampled with a radio frequency (RF) or an intermediate frequency (IF), to a detection frequency for a detection process. The digital down-converter comprises a first mixer for converting a frequency of the received signal to a frequency of a first IF signal; and a second mixer for converting the first IF signal converted by the first mixer to a second IF signal of the detection frequency, and outputting the second It signal as a complexed signal.

Preferably, a frequency of the first IF signal is ¼ of a sampling frequency.

Preferably, the digital down-converter further comprises an automatic gain control (AGC) amplifier for amplifying an output of the first mixer.

Preferably, the second mixer is constructed in a polyphase structure comprised of a decimation filter and a quadrature converter.

To achieve the above and other objects, there is provided a receiver comprising a digital down-converter including a first mixer for converting a frequency of a received signal, sampled with a radio frequency (RF) or an intermediate frequency (IF), to a frequency of a first IF signal, and a second mixer for converting the first IF signal converted by the first mixer to a second IF signal of a detection frequency for a detection process and then outputting the second IF signal as a completed signal; a radio receiver for receiving an input signal and providing the received signal to the digital down-converter for frequency conversion; a filter for attenuating an aliasing frequency component and an image frequency component of the first mixer in the digital down-converter, from an output of the radio receiver; and an analog-to-digital converter for sampling an output of the filter with a radio frequency or an intermediate frequency and providing the sampled signal to the digital down-converter.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a structure of a digital down-converter (DDC) according to a first embodiment of the present invention;

FIG. 2 is a block diagram illustrating a structure of a receiver including the digital down-converter shown in FIG. 1;

FIG. 3 is a block diagram illustrating a structure of a digital down-converter according to a second embodiment of the present invention; and

FIG. 4 is a block diagram illustrating a structure of a digital down-converter according to the prior art.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

A digital down-converter (DDC) according to an embodiment of the present invention is constructed as a digital signal processing circuit, which converts an input RF or IF signal to a first IF signal in the DDC by a real mixer in an initial stage in the DDC, converts the first IF signal to a second IF signal in the DDC, i.e., a detection frequency signal for a detection process, by a real-complex mixer (quadrature converter), and then complexes the converted detection frequency signal. Here, the “real mixer” refers to a mixer for performing operations on a real signal, and the “real-complex mixer” refers to a mixer for complexing a real input signal into a complex output signal by multiplying the real input signal by a complex local signal.

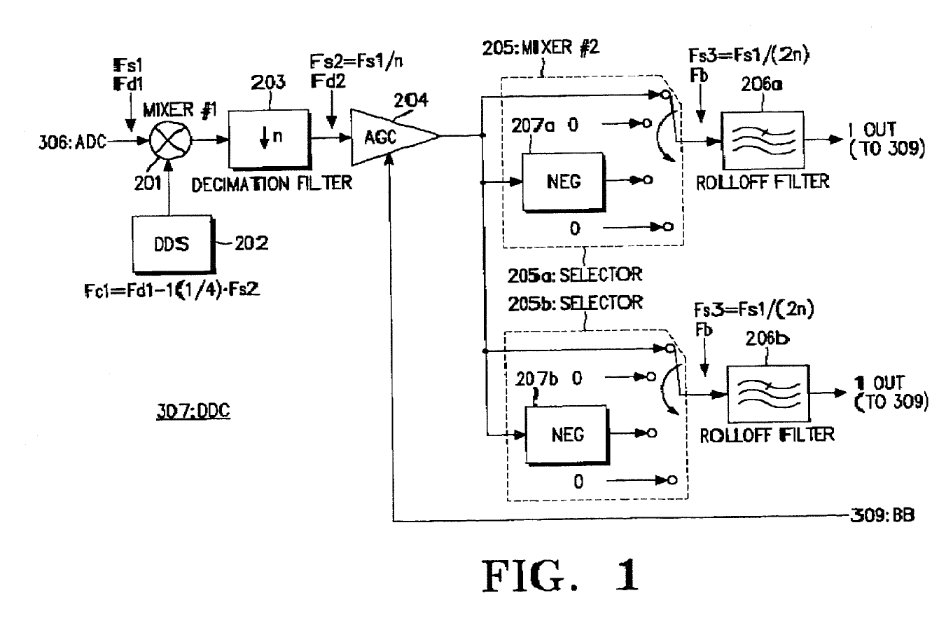

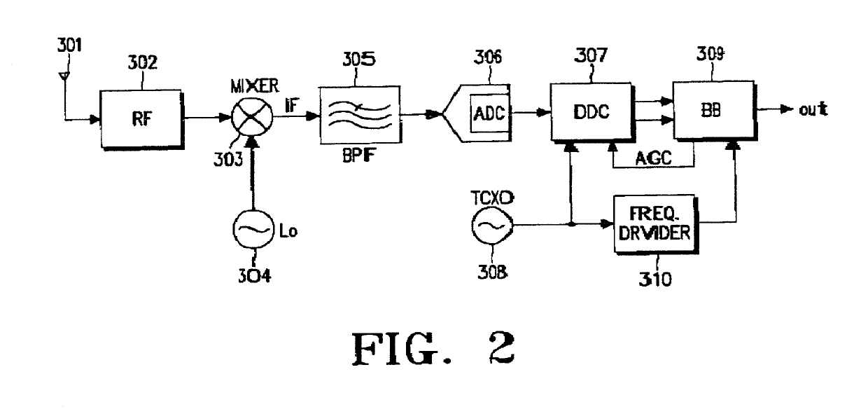

FIG. 1 is a block diagram illustrating a structure of a digital down-converter (DDC) 307 according to a first embodiment of the present invention, and FIG. 2 is a block diagram illustrating a structure of a receiver including the DDC 307 shown in FIG. 1.

Referring to FIG. 2, a signal received through an antenna 301 is converted to an IF signal through an RF unit 302, a mixer 303 and a local oscillator 304. The IF signal is band-pass filtered by an IF filter 305, which can be implemented with a band pass filter (BPF) for suppressing signals except the reception frequency band signals. An analog-to-digital (A/D) converter 306 samples the output of the IF filter 305 and then outputs a digital IF signal converted to a digital signal of a reception frequency Fd1. The digital IF signal is provided to the DDC 307. A sampling frequency of the A/D converter 366 is Fs1. The digital JF signal can be represented by Equation (1) below.

Digital IF Signal=fl(t)·cos(nωdl t) (1)

Reference numeral 308 indicates a local oscillator (or a temperature compensated crystal oscillator (TCXO)), reference numeral 309 indicates a baseband (BB) circuit, and reference numeral 310 indicates a frequency divider for generating a clock to be used in the BB circuit 309 by frequency-dividing the signal oscillated by the local oscillator 308 by 1/k.

Referring to FIG. 1, a first multiplier (mixer) 201, a real mixer, receives a a digital IF signal, represented by Equation (1), and a local signal c(t) of frequency Fc1, output from a local oscillator (DDS) 202, multiplies the received signals by each other, and then outputs a digital IF signal f2(t). Here, the local signal is represented by c(t)=cos(nωc1 t). As the result of the multiplication, the frequency Fd1 of the digital IF signal is converted to a frequency Fd2 which is 1/32 of the frequency Fs1. The frequency-converted digital IF signal f2(t) can be represented by Equation (2) below. Further, a relationship between the frequencies can be represented by Equation (3) below.

f2(t)=f1(t)·cos(n(ωd1−ωc1)t) (2)

Fc1=Fd1−Fs1/32 (3)

A decimation filter 203 receives the output signal f2(t) of the first mixer 201, suppresses a undesired signal of frequency (Fd1+Fc1) from the received signal f2(t), and at the same time, down-samples the received signal f2(t) into a sampling frequency Fs2 which is ⅛ of the received signal f2(t). That is, the first mixer 201 outputs a desired signal (Fd1−Fc1) and a undesired signal (Fd1+Fc1), and the decimation filter 203 outputs only the desired signal by suppressing the undesired signal among the signals output from the first mixer 201. Failure to suppress the undesired signal using the decimating filter 203 results in an aliasing problem. The aliasing problem can be resolved by suppressing the undesired signal as stated above. The digital IF signal f2(t) down-sampled to the frequency Fs2 can be represented by Equation (4) below. Hence, from Fs1=8×Fs2, a relationship between the frequencies can be expressed as Equation (5) below.

f2(t)=(½)f1(t) (e^{jn(ωd1-ωc1)t}+e^{-jn(ωd1-ωc1)t}) (4)

Fc=Fd1−[(¼)×Fs2] (5)

A frequency (first IF) of the digital IF signal f2(t) expressed by Equation (4) is ¼ the sampling frequency Fs2 as represented by Equation (5).

An AGC (Automatic Gain Control) amplifier 204 amplifies the digital IF signal ft(2) expressed by Equation (4) according to a control signal provided from the baseband circuit 309, and provides the amplified signal to a second mixer 205. The second mixer 205 multiplies the digital IF signal f2(t) amplified by the AGC amplifier 204 by ¼ the sampling frequency, i.e., a frequency Fc2=(¼)×Fs2, and converts the resulting signal to a baseband signal fb(t) of the detection frequency (second IF) for the detection process. The converted signal output from the second mixer 205 can be represented by Equation (6) below.

$$\begin{matrix}fb ( t ) = ( 1 / 2 ) f1 ( t ) {ⅇ}^{j n ( ω d1 - ω c1 - ω c2 ) t} \\ = ( 1 / 2 ) f1 ( t ) {ⅇ}^{j n \{ ω d1 - \{ ω d1 - \{ ω s2 \} / 4 \} \} - \{ ( ω s2 ) / 4 \} \} \} t} \\ = ( 1 / 2 ) f1 ( t )\end{matrix} \qquad ( 6 )$$

Rolloff filters 206a and 206b rolloff-shape the baseband signal fb(t), and output complex signals of an in-phase component I and a quadrature component Q.

The second mixer 205, a real-complex mixer (quadrature converter), is comprised of a multiplier for multiplying the output of the AGC amplifier 204 by ¼ the sampling frequency and a complexing means for complexing the multiplied signal. The multiplication value by the multiplier is determined as cosine part values 1, 0, −1, 0, 1, . . . and sine part values 0, 1, 0, −1, 0, . . . of the frequency oscillated by the local oscillator. Therefore, it is possible to easily construct the DDC using the selectors 205a and 205b as shown in FIG. 1, without including a separate multiplier in the second mixer 205.

The selector 205a is a selector for cyclically selecting such multiplication values as 1, 0, −1, 0, 1, . . . , which are cosine wave values oscillated by the local oscillator, and selects one of the 4 multiplication values. The “4 multiplication values” refer to a multiplication result corresponding to a multiplication value ‘1’, which is the output of the AGC amplifier 204, a multiplication result ‘0’ corresponding to a multiplication value ‘0’, a multiplication result corresponding to ‘−1’, which is the output of a sign inverter (NEG) 207a for inverting the output of the AGC amplifier 204, and a multiplication result ‘0’ corresponding to a multiplication value ‘0’.

The selector 205b is a selector for cyclically selecting such multiplication values as 0, 1, 0, −1, 0, . . . , which are sine wave values oscillated by the local oscillator, and selects one of the 4 multiplication values, like the selector 205a. The “4 multiplication values” refer to a multiplication result ‘0’ corresponding to a multiplication value ‘0’, a multiplication result corresponding to a multiplication value ‘1’, which is the output of the AFC amplifier 204, a multiplication result ‘0’ corresponding to a multiplication value ‘0’, and a multiplication result corresponding to a multiplication value ‘−1’, which is the output of a sign inverter 207b for inverting the output of the AGC amplifier 204.

The DDC according to an embodiment of the present invention performs two separate steps of conversion for high-precise tuning and conversion for complexing, instead of converting the input signal to a desired frequency at once, thereby contributing to a reduction in the circuit size and power consumption.

Although the input frequency, fd1′=fc1−(fs1/32), of the DDC becomes an image frequency of the first mixer 201, an interference signal can be suppressed by the analog filter (IF filter 305) arranged in front of the A/D converter 306. Here, the image frequency corresponds to a frequency of the desired signal output from the first mixer 201. That is, when the signal frequency fd1 is expressed from the relationship between the local signal frequency Fc1 from the local oscillator 202 and the IF signal frequency Fif1 output from the first mixer 201, a desired signal frequency becomes Fdesired=Fif1+Fc1 and an image signal frequency becomes Fimage=−Fif1+Fc1. Since restricting the signal to the channel band can be performed in the DDC 307, the analog filter 305 only needs to suppress the interference signal of the aliasing frequency and the image frequency.

This embodiment can simplify a process for the second IF signal (the process by the second mixer 205) by converting the frequency of the first IF signal in the DDC 307 to ¼ the sampling frequency. In addition, since this embodiment performs the process of the second mixer 205 after decreasing the sampling frequency, thus simplifying the mixing process, the power consumption of the second mixer 205 is very low compared with the total power consumption of the DDC 307.

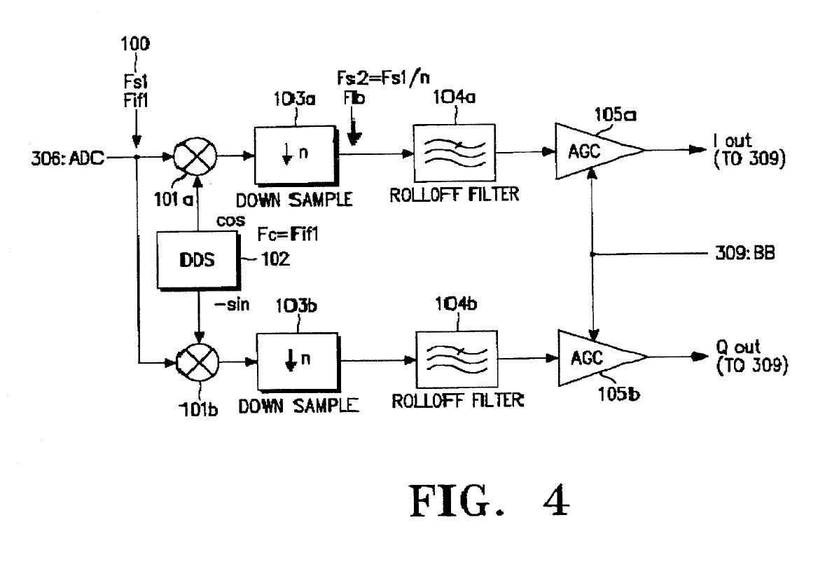

As mentioned above, the digital receiver according to the prior art generally converts the received signal to a baseband signal at once. The conventional receiver is advantageous in that the decimation filter for processing the converted baseband signal and the local filter can both be constructed with a lower pass filter (LPF). For information, the BPF is higher than the LPF in a filter order. Having such an advantage, the conventional technology has never considered designing the IF signal in the digital signal processor as set forth in the first embodiment of the present invention. According to the conventional technology shown in FIG. 4, most distortion of the received signal occurs within the band of the received signal, during variations in gain of the AGC amplifier 105a. However, since the distortion occurring by the AGC amplifier 105a cannot be reduced by the filter, there is a demand for a process algorithm for low AGC distortion to reduce distortion due to the AGC process.

Therefore, the embodiment of the present invention arranges the AGC amplifier 204 in front of the second mixer 205 in the digital IF signal processor, so that the harmonic distortion caused by the AGC amplifier 204 may occur out of the band of the received signal. By suppressing the distortion of the non-received signal band using the IF filter 305 for suppressing the unwanted signal and the aliasing signal, it is possible to reduce the distortion conventionally caused by the AGC process without designing the process algorithm for the low AGC distortion.

The DDS 202 is comprised of a phase operator of frequency Fc1 and a ROM in which amplitude values corresponding to the outputs of the phase operator are written. The output of the ROM serves as a local signal c(t) of frequency Fc1. In the DDS 202, the spurious characteristic caused by the phase error is improved by 6.02 dB each time a difference (requantization error) between phase word lengths (address length, i.e., ROM capacity) of the phase operator and the ROM is decreased by one bit. In addition, when the length of the ROM data increases by one bit, the spurious characteristic caused by the output word length (ROM data length) of the DDS 202 is improved by 6.02 dB. If, for example, the phase operation word length is fixed for improvement of the spurious characteristic, each time the address word length of the ROM is increased by one bit, the circuit size (ROM capacity) is doubled and power consumption is also doubled.

However, in a receiver having less strict restriction on power consumption, it is possible to improve the spurious characteristic of the local oscillator (DDS) 202, by utilizing the reduced circuit size and power consumption by the embodiment in increasing the ROM capacity (address length and data length).

As described above, according to the first embodiment of the present invention, the number of mixers in the initial stage is decreased to 1 from 2, and the local oscillator outputs only one of the cosine wave and the sine wave. In addition, the decimation filters in the initial stage, for down-converting the mixer signal and the sampling frequency, are also halved in number, so that the digital down-converter according to an embodiment of the present invention halves the number of the mixers, the local oscillators and the decimation filters, conventionally required for high-speed processing, and also halves the power consumption.

In addition, the second mixer 205 can implement signal passing and signal inversion with a selector by converting the input frequency to ¼ the sampling frequency, and is not required to use a separate multiplier. As a result, the conventional mixer circuit having high power consumption and high operating speed is considerably simplified in structure, thus decreasing the overall power consumption of the DDC.

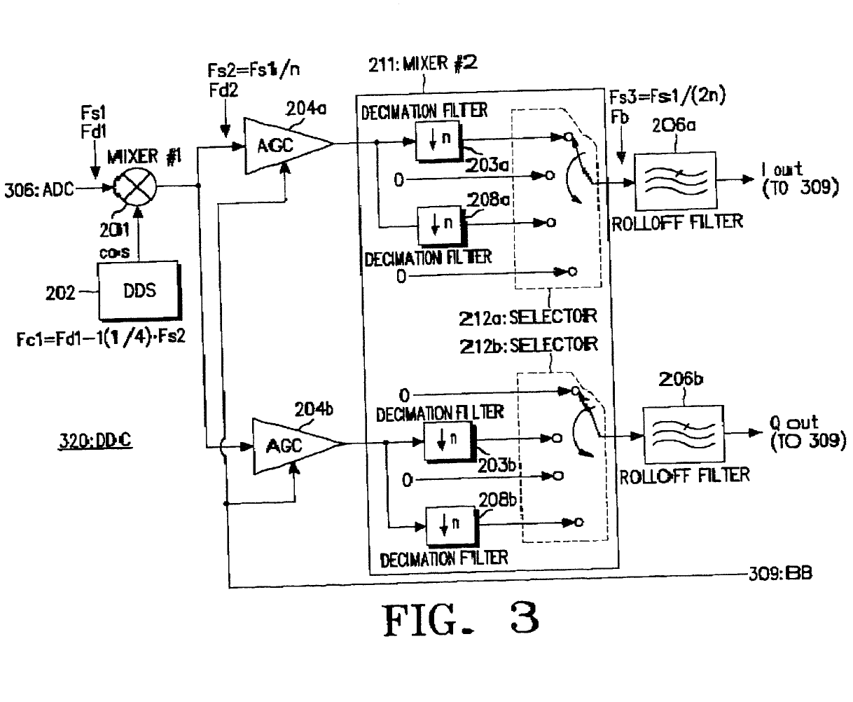

FIG. 3 is a block diagram illustrating a structure of a digital down-converter 320 according to a second embodiment of the present invention. In FIG. 3, the same elements as shown in FIG. 1 are assigned the same reference numerals, and the description of them will not be provided for simplicity. The DDC 320 shown in FIG. 3 has a polyphase structure in which the decimation filter 230 and the second mixer (quadrature converter) 205 of the DDC 307 shown in FIG. 1 are united. Actually, such a polyphase structure is often used to construct the digital down-converter (DDC).

Referring to FIG. 3, like the second mixer 205 of FIG. 1, a second mixer 211 is comprised of a cosine part and a sine part of a frequency oscillated by the local oscillator. The cosine part of the local oscillation frequency is comprised of a selector 212a and two decimation filters 203a and 208a. The sine part of the local oscillation frequency is comprised of a selector 212b and two decimation filters 203b and 208b. The decimation filters 208a and 208b have a sign inversion function for inverting a sign of coefficients. Two AGC amplifiers 204a and 204b are arranged in front of the second mixer 211. The AGC amplifiers 204a and 204b amplify the outputs of the first mixer 201 and provide the amplified signals to the cosine part and the sine part of the local oscillation frequency.

In the cosine part and the sine part of the second mixer 211, the output of the first mixer 201, as a multiplication result corresponding to a multiplication value ‘1’, is amplified by the AGC amplifiers 204a and 204b, and the amplified results are provided to the selectors 212a and 212b through the decimation filters 203a and 203b, respectively. As a multiplication result corresponding to a multiplication value ‘−1’, the output of the first mixer 201 is amplified by the AGC amplifiers 204a and 204b, and the amplified results are provided to the selectors 212a and 212b through the decimation filters 208a and 208b, respectively.

An input frequency Fs2 (first IF) provided to the second mixer 211 from the first mixer 201 is 1/n the sampling frequency Fs1, and the operating frequency of the second mixer 211 becomes Fs2=Fs1/n. Here, since the second mixer 211 switches the paths (inputs selected by the selectors 212a and 212b) operating at every sampling phase, an operating frequency of each path of the second mixer 211 becomes ¼ the frequency Fs2, even though the sampling frequency in the second mixer 211 is Fs2. At this moment, a relationship between the frequencies is expressed as:

(¼)Fs2=(½)Fs3=(¼n)Fs1 (7)

Since the second mixer 211 selects out the samples whose output is ‘0’, it can perform down-sampling in a state where the aliasing has not occurred yet. At this moment, a relationship between the frequencies can be represented by:

Fs3=Fs2/2=Fs1/(2n) (8)

Meanwhile, when the second mixer 211 is constructed in the polyphase structure, two multipliers are used: one for the cosine part and another for the sine part. However, like the DDC 307 according to the first embodiment, the DDC 320 according to the second embodiment can be embodied without using the multiplier, by converting the input frequency of the second mixer 211 to ¼ the sampling frequency Fs1. As a result, even when the digital down-converter (DDC) is constructed in the polyphase structure, it is possible to simplify the second mixer 211 and reduce the power consumption of the DDC by converting the frequency of the first IF signal to ¼ the sampling frequency, as stated above.

The DDC 320 according to the second embodiment, which is an element of the receiver shown in FIG. 2, can replace the DDC 307 according to the first embodiment.

The DDC 307 according to the second embodiment is applicable to a receiver included in a mobile terminal or a mobile phone, its base station, and a broadcasting device, and has the following advantages by virtue of the reduced power consumption:

(1) The DDC contributes to an extension of a run time of the mobile terminal or the mobile phone. In addition, for the same run time, the mobile terminal requires low battery capacity leading to a reduction in the battery size.

(2) When the DDC is applied-to the receiver in the base station or the broadcasting device, the receiver generates less heat. The decrease in the heat generated in the receiver can simplify the heat radiator, contributing to miniaturization of the device.

(3) The DDC 307 has a simple digital processing operation. As a result, when the receiver using the DDC 307 is required to improve its performance rather than reducing power consumption, it is possible to increase operations for the high-precise algorithm process or the digital signal processing operation word length as much as the simplified operations, i.e., as much as the saved power consumption.

As described above, the novel digital down-converter for converting a frequency of a signal, received at a radio receiver and sampled with a radio frequency or an intermediate frequency, to a detection frequency for the detection process, includes a first mixer for converting the frequency of the received signal to a first IF signal, and a second mixer for converting the first IF signal converted by the first mixer to a second IF signal of the detection frequency, and a complexing means for complexing the converted signal. Therefore, the structures of the mixer, the local oscillator and the decimation filter in the initial stage are simplified, resulting in a reduction in power consumption. In addition, when the frequency of the first IF signal is converted to ¼ the sampling frequency, the conventional mixer having high power consumption and high operation speed is significantly simplified, further reducing power consumption.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A digital down-converter for converting a frequency of a signal, received at a radio receiver and sampled with a radio frequency (RF) or an intermediate frequency (IF), to a detection frequency for a detection process, comprising:
a first mixer for converting a frequency of the received signal to a frequency of a first IF signal; and
a second mixer for converting the first IF signal converted by the first mixer to a second IF signal of the detection frequency, and outputting the second IF signal as a complexed signal.

2. The digital down-converter as claimed in claim 1, wherein a frequency of the first IF signal is ¼ a sampling frequency.

3. The digital down-converter as claimed in claim 2, further comprising an automatic gain control (AGC) amplifier for amplifying an output of the first mixer.

4. The digital down-converter as claimed in claim 2, wherein the second mixer is constructed in a polyphase structure comprised of a decimation filter and a quadrature converter.

5. A receiver comprising:
a digital down-converter including a first mixer for converting a frequency of a received signal, sampled with a radio frequency (RF) or an intermediate frequency (IF), to a frequency of a first IF signal, and a second mixer for converting the first IF signal converted by the first mixer to a second IF signal of a detection frequency for a detection process and then outputting the second IF signal as a complexed signal;
a radio receiver for receiving an input signal and providing the received signal to the digital down-converter for frequency conversion;
a filter for attenuating an aliasing frequency component and an image frequency component of the first mixer in the digital down-converter, from an output of the radio receiver; and
an analog-to-digital converter for sampling an output of the filter with a radio frequency or an intermediate frequency and providing the sampled signal to the digital down-converter.

6. The receiver as claimed in claim 5, wherein a frequency of the first IF signal is ¼ a sampling frequency.

7. The receiver as claimed in claim 6, further comprising an automatic gain control (AGC) amplifier for amplifying an output of the first mixer of the digital down-converter.

8. The receiver as claimed in claim 6, wherein the second mixer of the digital down-converter is constructed in a polyphase structure comprised of a decimation filter and a quadrature converter.
